(19) United States
(12) Patent Application Publication
(10) Pub. No.: US 2006/0120259 A1
(43) Pub. Date: Jun. 8, 2006

(54) Optical disc, optical disc apparatus, and optical disc reproducing method

(76) Inventors: Toshihiro Sugaya, Moriya-shi (JP); Hisashi Yamada, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/293,366

(22) Filed: Dec. 5, 2005

(30) Foreign Application Priority Data
Dec. 6, 2004 (JP) 2004-352522

(51) Int. Cl. G11B 7/24

(52) U.S. Cl. 369/275.1; 369/283

(57) ABSTRACT

A single-sided dual layer optical disc of the invention comprises a first light transmission layer, a first recording layer which is accessed with a first laser beam, a second light transmission layer, and a second recording layer which is accessed with a second laser beam, these layers being arranged in that order from an incidence plane in the direction of incidence, the distance from the incidence plane to the second recording layer being 570 to 630 Am, and the areal recording density of the first recording layer being five times or more as high as that of the second recording layer.

### CROSS-REFERENCE TO RELATED APPLICATIONS

This application is based upon and claims the benefit of priority from prior Japanese Patent Application No. 2004-352522, filed Dec. 6, 2004, the entire contents of which are incorporated herein by reference.

### BACKGROUND OF THE INVENTION

1. Field of the Invention

This invention relates to an optical disc acting as a medium which stores digitized audio and visual contact, including movies and music, such as Digital Versatile Disc (DVD). This invention further relates to an optical disc apparatus and an optical disc reproducing method which read the information recorded on the optical disc.

2. Description of the Related Art

<Outline of the DVD Standard>

One known type of optical disc for storing digital images is Digital Versatile Disc (DVD), which has been widely used all over the world mainly in storing and delivering movie content (digital publications). DVD is the standard determined by the DVD forum, which is open to the public as the DVD standard (DVD Book). The DVD standard has also been determined in International standards and JIS. Here, the ECMA standard for 120 mm DVD-ROM, one of the DVD physical standards, will be explained briefly, referring to non-patent document ECMA-267 (corresponding to ISO/IEC 16448).

There are four types of 120 mm DVD-ROM: single-sided single layer, single-sided dual layer, double-sided single layer, and double-sided dual layer. In delivery of an accumulation of content, such as movies, there are two types of single-sided discs: one is a single-sided single layer disc with a capacity of 4.7 GB and the other is a single-sided dual layer disc with a capacity of 4.27 GB per layer (a total capacity of 8.54 GB per disc).

The development of a disc whose capacity is larger than that of the aforementioned DVD (referred to as the existing DVD) has been desired. This comes from a desire to store high-definition (HD) images into a single disc (temporarily referred to as a next-generation DVD). The next-generation DVD may be a Blu-ray disc (BD) or a High-Definition (HD) Digital Versatile Disc (HD DVD).

### BRIEF SUMMARY OF THE INVENTION

If the next generation DVD has been developed, it will be possible to design a next-generation DVD device (drive or player) for the next-generation DVD so as to be capable of reading not only the next-generation DVD but also the existing DVD. However, since the next-generation DVD differs greatly from the existing DVD in recording density, modulation system, signal processing, track format, and the like, a conventional DVD device (drive or player) cannot read the data from the next-generation DVD. That is, the conventional DVD device has the disadvantage of being unable to read not only the high-definition movie content recorded on the next-generation DVD disc but also the conventional DVD movie content recorded on the next-generation DVD, which may lead to a factor that hinders the spread of the next-generation DVD.

It is, accordingly, an object of the present invention is to provide an optical disc, an optical disc apparatus, and an optical disc reproducing method which enable a single disc to deal with not only the information recorded on a BD (a next-generation DVD) and the information recorded on an existing DVD but also the information recorded on a BD and the information recorded on an HD DVD (a next-generation DVD).

According to a first aspect of the present invention, there is provided an optical disc of a single-sided dual layer comprising: a first light transmission layer; a first recording layer which is accessed with a first laser beam; a second light transmission layer; and a second recording layer which is accessed with a second laser beam, these layers being arranged in that order from an incidence plane in the direction of incidence, the distance from the incidence plane to the second recording layer being 570 to 630 μm, and the areal recording density of the first recording layer being five times or more as high as that of the second recording layer.

According to a second aspect of the present invention, there is provided an optical disc of a single-sided dual layer comprising: a first light transmission layer; a first recording layer which is accessed with a first laser beam; a second light transmission layer; and a second recording layer which is accessed with a second laser beam, these layers being arranged in that order from an incidence plane in the direction of incidence, the distance from the incidence plane to the second recording layer being 578 to 622 μm, and the areal recording density of the first recording layer being 1.5 times or more as high as that of the second recording layer.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows the relationship between the basic structure of a single-sided single layer DVD disc and an optical head;

FIG. 2A shows the position of the recording layer of the single-sided single layer DVD disc;

FIG. 2B shows the position of the recording layer of the single-sided single layer DVD disc;

FIG. 3 shows the relationship between the basic structure of a single-sided dual layer DVD disc and an optical head;

FIG. 4 shows the position of the recording layer of the single-sided dual layer DVD disc;

FIG. 5 shows the relationship between the basic structure of a single-sided single layer HD DVD disc and an optical head;

FIG. 6 shows the relationship between the basic structure of a single-sided dual layer HD DVD disc and an optical head;

FIG. 7 shows the position of the recording layer of the single-sided dual layer HD DVD disc;

FIG. 8 shows the relationship between the basic structure of a single-layer BD-ROM disc and an optical head;

FIG. 9 shows the relationship between the basic structure of an optical disc (BD and DVD) according to a first embodiment of the present invention and an optical head;

FIG. 10 shows a state where the optical disc of the first embodiment is played back with a red laser beam;

FIG. 11 shows a state where the optical disc of the first embodiment is played back with a blue-violet laser beam;

FIG. 12 shows the relationship between the basic structure of an optical disc (BD and HD DVD) according to a second embodiment of the present invention and an optical head;

FIG. 13 shows a state where data recorded in the BD layer and HD DVD layer of the second embodiment is reproduced using a blue-violet laser beam;

FIG. 14 shows a configuration of an optical disc apparatus complying with the DVD standard;

FIG. 15A is a flowchart to help explain the operation of the optical disc apparatus complying with the DVD standard; and

FIG. 15B shows an example of the waveforms of focus signals.

### DETAILED DESCRIPTION OF THE INVENTION

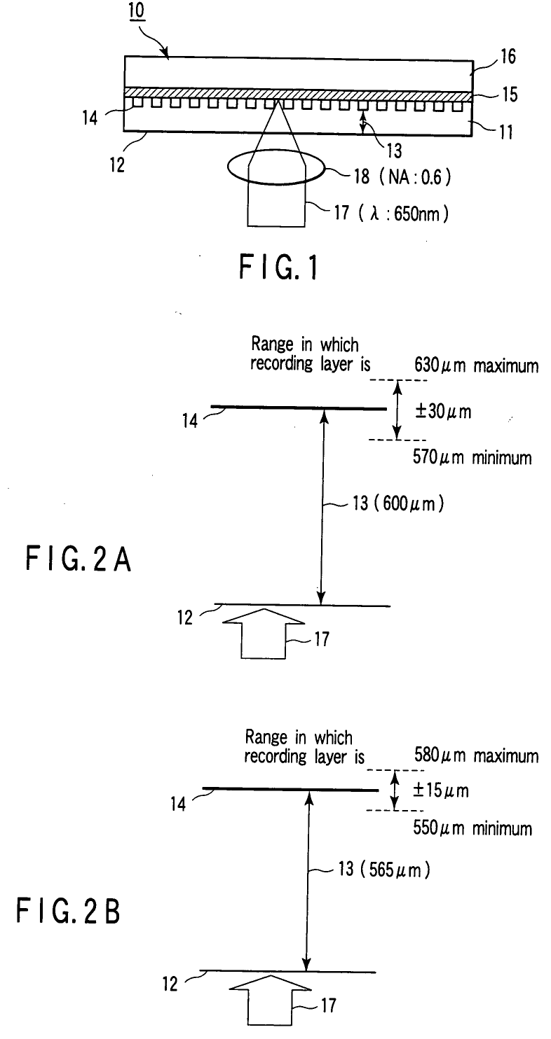

Hereinafter, referring to the accompanying drawings, embodiments of the present invention will be explained. To make it easier to understand the present invention, the technologies of the existing DVD and the next-generation DVD (BD) will be explained using FIGS. 1 to 8. Then, the basic configuration of a next-generation DVD (BD and existing DVD) according to the present invention will be explained using FIG. 9.

<Single-Sided Single Layer DVD>

FIG. 1 shows the relationship between the basic structure of a single-sided single layer DVD disc 10 and an optical head. As is well known, the DVD disc 10 has such a structure as bonded two 0.6 mm thickness disc substrates together. One of the substrates is a signal substrate 11 and the other is a dummy substrate 16. The signal substrate and the dummy substrate are bonded together with an adhesive layer 15 in such a manner that a recording layer 14 lies between the two substrates. Generally, these substrates are made of such plastic material as polycarbonate with an injection molding machine.

In the signal substrate 11, video information, data information, and the like are recorded in a spiral track in the form of emboss pits. Red laser light 17 (with a wavelength of 650 nm) for reading the information in the recording layer is stopped down at an objective lens 18 (with an NA of 0.6), passes through a light transmission layer 13 of the signal substrate 11, and is focused on the recording layer 14.

Each of FIGS. 2A and 2B shows the position of the recording layer of a single-sided single layer disc when viewed from an incidence plane 12.

FIG. 2A shows a normal single layer conventionally used. In the normal single layer, the center value of the thickness of the light transmission layer 13 is 600 μm and lies in a position a minimum distance of 570 μm and a maximum distance of 630 μm away from the incidence plane. The value is determined, taking the spherical aberration of the objective lens 18 into account.

FIG. 2B shows a thin single layer which conforms to the DVD standard and is used these days. In the thin single layer, the center value of the recording layer is 565 μm and lies in a position a minimum distance of 550 μm and a maximum distance of 580 μm away from the incidence plane. In this disc, jitter is determined to be 7% or less to secure interchangeability in reading with a conventional apparatus, whereas in the normal signal layer, jitter is determined to be 8% or less.

Although the minimum distance from the incidence plane is 550 μm in the added standard, if jitter can be reduced to 7% or less as in the thin single layer, the maximum distance from the incidence plane can be increased to 640 μm as in a two-layer disc.

<Single-Sided Dual Layer DVD>

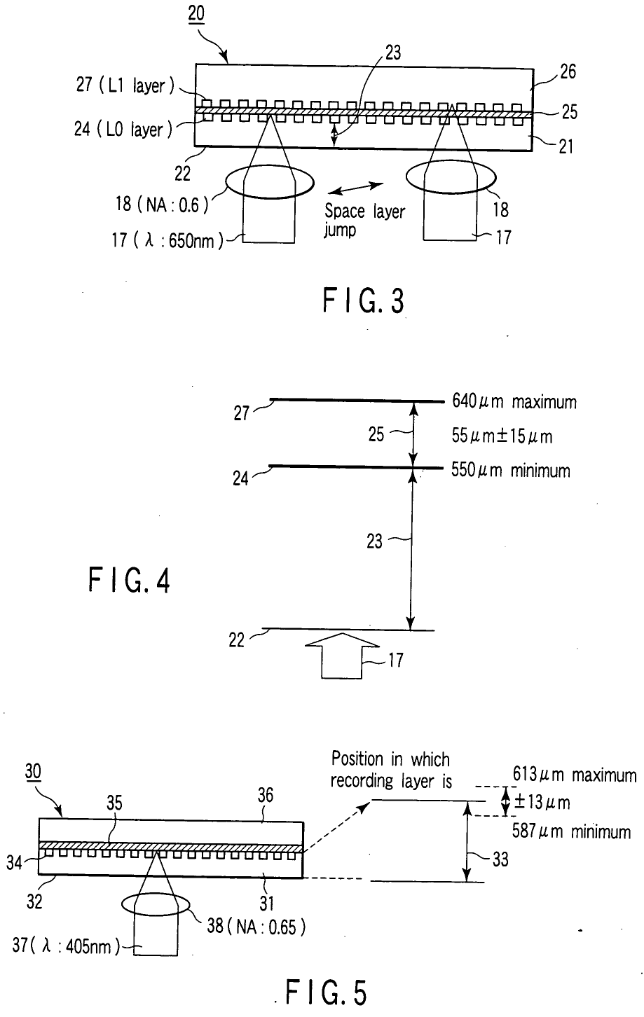

FIG. 3 shows the relationship between the basic structure of a single-sided dual layer disc 20 and an optical head. As is well known, this disc has a first recording layer (L0 layer) 24 and a second recording layer (L1 layer) 27. The two recording layers can be accessed from one side of the disc, thereby reproducing the signal. In FIG. 3, when viewed from the incidence plane 22, there are a light transmission layer 23, the first recording layer (L0 layer) 24, and the second recording layer (L1 layer) 27 in that order. The individual recording layers are accessed by the red laser light according to the objective lens 18 is moving under controlling of a lens actuator, and causing an layer jump of the red laser light.

The dual layer disc is characterized in that it can be produced almost in the same manner as a single-sided single layer disc. A signal substrate 21 where the first recording layer (L0 layer) 24 is to be formed and a signal substrate 19 where the second recording layer (L1 layer) 27 is to be formed are produced separately with an injection molding machine. Next, a translucent film is provided on the first recording layer (L0 layer) 24 and a high-reflectivity film is provided on the second recording film (L1 layer) 27. Then, the two substrates are bonded together with a space layer 25 in such a manner that the recording layers lie between the two substrates, which completes the disc.

FIG. 4 shows the positions of the recording layers when viewed from the incidence plane 22 of the single-side dual layer disc. The first recording layer (LO layer) 24 is limited to a position a minimum distance of 550 μm away from the incidence plane and the second recording layer (L1 layer) 27 is limited to a position a maximum distance of 640 μm away from the incidence plane and the distance between the two layers (or space layer 25) is set at 55±15 μm (40 to 70 μm), taking into account the spherical aberration of the objective lens 18 and crosstalk between the recording layers. The space layer 25 is generally equal to the thickness of the adhesive layer with which the two substrates are bonded together. In an actual manufacture, the distance is determined, taking into account the bonding accuracy and the formation accuracy of the signal substrate 21. The line recording density is reduced by 10% in a single-sided single layer disc. The capacity per layer is 4.27 GB. Jitter is determined to be 8% or less.

<Reflectivity and Others of the Recording Layers>

The Reflectivities of the recording layers are determined as follows:

Single-layer disc: 45% to 85% (with PBS), 60% to 85% (without PBS: circularly polarized light)

Dual layer disc: 18% to 30% (with PBS), 18% to 30% (without PBS: circularly polarized light)

Information indicating the Reflectivity of the disc is b29 in a 4-byte ID (Identification Data) in a Data frame:

0b: when the Reflectivity is larger than 40% (with PBS)

1b: when the Reflectivity is equal to or smaller than 40% (with PBS)

Moreover, in the ID, the following have been written:

| | | |
|---|---|---|
| Area type | b27 to b26 | |
| | 00b | In the data area |
| | 01b | In the lead-in area |
| | 10b | In the lead-out area |
| | 11b | In the middle area |
| Data type | b25 | |
| | 0b | Read-only data |
| | 1b | Other than Read-only data |
| Layer number | b24 | |
| | 0b | Layer0 of DL discs or on |
| | | SL discs |
| | 1b | Layer1 of DL discs |

As for information as to whether the disc has a single layer or a dual layer, a disc structure is defined in byte position BP2 in the Control data zone. In the information, b5 and b6 represent the number of recording layers:

00b Single

01b Dual

Others: reserved

Furthermore, the capacity per layer in a single-layer disc differs from that in a dual layer disc, since the single-layer disc differs from the dual layer disc in linear recording density. Recording density is defined in BP3 in such a manner that b7 to b4 represent a linear recording density as follows:

0000b: 0.267 μm (the linear recording density for a single layer)

0001b: 0.293 μm (the linear recording density for a dual layer)

<HD DVD>

A blue-violet semiconductor laser (hereinafter, referred to as blue-violet laser) HD DVD whose recording density is three times or more as high as that of DVD has been proposed to satisfy a desire to store high definition (HD) images onto a single disc. The blue-violet laser HD DVD has been standardized in the DVD forum.

HD DVD has the same disc structure as that of a conventional DVD. A single-sided single layer HD DVD has a capacity of 15 GB and a double-sided dual layer HD DVD has a capacity of 30 GB. These large capacities have been realized by new techniques, including a shorter wavelength of laser light, a larger NA, a modulation system, and new signal processing (Partial Response and Maximum Likelihood [PRML]).

FIG. 5 shows the relationship between the basic structure of a single-sided single layer HD DVD disc and an optical head. Like the DVD disc 10, the HD DVD 30 has such a structure as has two 0.6 mm thickness disc substrates bonded together as shown in FIG. 5. One is a signal substrate 31 and the other is a dummy substrate 36. The two substrates are bonded together with an adhesive layer 35 in such a manner that a recording layer 34 between the two substrates. The center value of the maximum and minimum values of the thickness of a light transmission layer 33 is 600 μm. Because of the spherical aberration of the objective lens 38, the thickness of the light transmission layer 33 has a maximum value of 613 μm and a minimum value of 587 μm. The recording layer 34 formed at the signal substrate 31 is read with a blue-violet laser beam 37 (with a wavelength of 405 nm) stopped down with the objective lens 38 (with an NA of 0.65).

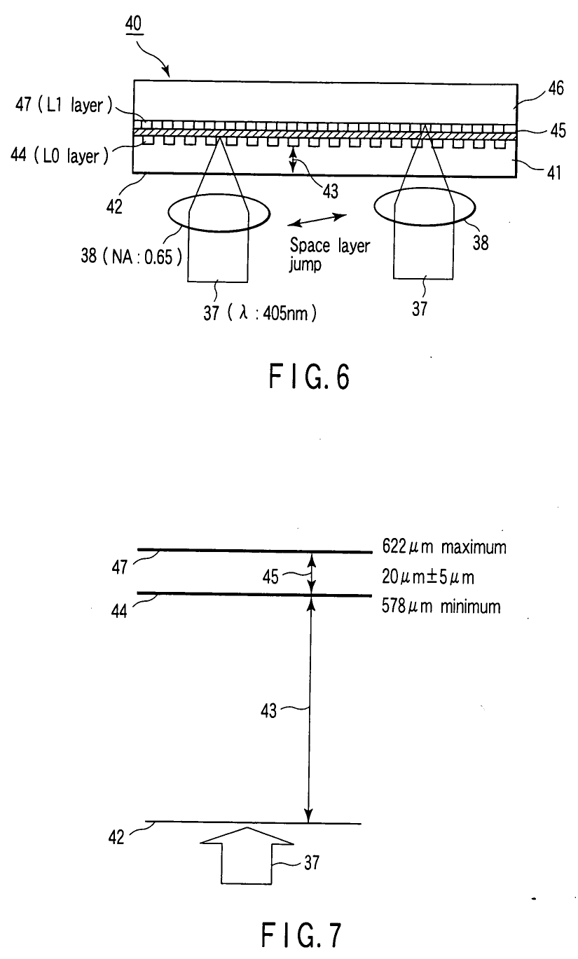

FIG. 6 shows the relationship between the basic structure of a single-sided dual layer HD DVD disc 40 and an optical head. As shown in FIG. 6, the HD DVD disc 40 has such a structure as has a signal substrate 41 (where a first recording layer (L0 layer) 44 has been formed) and a signal substrate 46 (where a second recording layer (L1 layer) 47 has been formed) bonded together with a space layer 45. As in DVD, causing the focused position of the laser beam to jump between the recording layers enables the recording layer 44 or 47 to be accessed from one side of the disc.

FIG. 7 shows the positions of the recording layers of the single-sided dual layer HD DVD when viewed from the incidence plane 42. Since the spherical aberration becomes severer as a result of making the wavelength shorter and NA larger, the first recording layer (L0 layer) 44 is limited to a position a minimum distance of 578 μm away from the incidence plane and the second recording layer 53 is limited to a position a maximum distance of 622 μm away from the incidence plane. The distance between the two layers (or space layer 45) is determined to be 20±5 μm (15 to 25 μm)

<Blue-Ray Disc>

One type of optical disc dealing with HD video is a blue-ray disc which uses a blue-violet laser and a high NA objective lens to achieve a high recording density and a large capacity. Recently, the BD-ROM standard has been reported for Read only discs which enable HD video or the like to be recorded and can be distributed. Its outline has been disclosed in Technical White Paper.

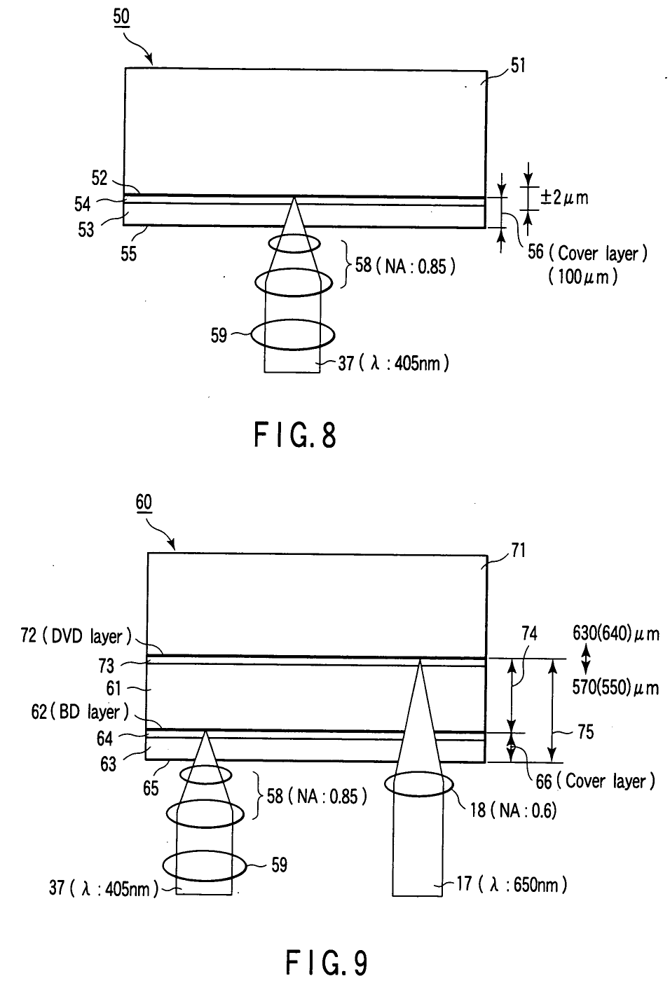

FIG. 8 shows the relationship between the basic structure of a single-sided BD-ROM disc and an optical head. The BD disc 50 is composed of a plastic signal substrate 51 (with a thickness of 1.1 mm) where a recording layer 52 has been formed and a 0.1 mm thickness light transmission layer (cover layer) 56. The cover layer 56 is composed of a transparent cover film 53 and an adhesive layer 54. A blue-violet laser beam (with a wavelength of 405 nm) stopped down with a high NA objective lens 58 (with an NA of 0.85) is irradiated from the incidence plane 55 onto the recording layer 52, thereby reading the information in the recording layer.

In DVD and HD DVD, the thickness of the light transmission layer is about 0.6 mm, which increases resistance to dirt or flaws at the incidence plane. In BD discs, emphasis is placed on increasing the recording density and the thickness of the cover layer is set at 0.1 mm so that an objective lens with an NA of 0.85 can be used. Since dirt attached to or flaws in the incidence plane 55 become a problem, a special coating is applied to the disc surface.

Since a high NA lens is used, an error in the thickness of the cover layer leads to a great spherical aberration. Therefore, an error in the DC thickness is removed by a spherical aberration compensating lens 59 in such a manner that fluctuation components in one period are suppressed to +2 μm. Since the cover layer (light transmission layer) 56 is composed of the cover film 53 and adhesive layer 54, a fluctuation in the thickness of each layer must be suppressed to about +1 μm. BD discs are required to have one digit severer production accuracy than that of DVD or HD DVD. The spacing between the objective lens 58 and the incidence plane 55 is about 1.6 mm in DVD and HD DVD. BD discs are characterized in that the spacing between the objective lens 58 and the incidence plane 55 is as narrow as 0.1 mm to 0.3 mm.

<Interchangeability Between DVD, HD DVD, and Blu-Ray Discs>

As described above, HD DVD and BD have been proposed as large capacity optical discs capable of storing HD video. However, since the structure of a BD disc is completely different from those of DVD and HD DVD, there is a big problem with the interchangeability between them.

<The Basic Concept of this Invention is as Follows>

An optical disc according to the present invention is basically specified by the following items (1) to (3):

(1) The optical disc is a single-sided dual layer optical disc where a first light transmission layer, a first recording layer accessed with a first laser beam, a second light transmission layer, and a second recording layer accessed with a second laser beam are arranged in that order in the direction in which the laser beam enters.

(2) The distance from the incidence plane to the second recording layer is 570 to 630 μm.

(3) The areal recoding density of the first recording layer is five times or more as high as that of the second recording layer.

Moreover, the optical disc of the present invention can be embodied on the basis of not only the above basic items but also the following items (4) to (6):

(4) The distance from the incidence plane to the first recording layer is about 100 A m.

(5) The reflectivity of the first recording layer with respect to the first laser beam is 4% or more.

(6) The reflectivity of the second recording layer with respect to the second laser beam is 45% or more.

An optical disc apparatus according to the present invention is specified by the following items (7) to (9):

(7) The optical disc is a single-sided dual layer optical disc where a first light transmission layer, a first recording layer accessed with a first laser beam, a second light transmission layer, and a second recording layer accessed with a second laser beam are arranged in that order in the direction in which the laser beam enters.

(8) The distance from the incidence plane to the second recording layer is 578 to 622 μm.

(9) The areal recoding density of the first recording layer is 1.5 times or more as high as that of the second recording layer.

Moreover, the optical disc apparatus of the present invention can be embodied on the basis of not only the above basic items but also the following items (10) to (12):

(10) The distance from the incidence plane to the first recording layer is about 100 μm.

(11) The reflectivity of the first recording layer with respect to the first laser beam is 12% or more.

(12) The reflectivity of the second recording layer with respect to the second laser beam is 18% or more.

According to the present invention, it is possible to provide an optical disc which enables a first recording layer (corresponding to a BD layer) and a second recording layer (corresponding to a DVD layer) to be accessed from one side with a first laser beam (blue-violet laser light) and a second laser beam (red laser light), respectively. Therefore, BD content and DVD content can be recorded into a single disc, which enables the user to enjoy the DVD content even with a conventional apparatus without a BD reproducing function. Moreover, use of an apparatus with a BD reproducing function enables the user to enjoy BD content (e.g., HD content).

In another example, it is possible to provide an optical disc which enables a first recording layer (corresponding to a BD layer) and a second recording layer (corresponding to an HD DVD layer) to be accessed from one side with a first laser beam (blue-violet laser light) and a second laser beam (blue-violet laser light), respectively. In the prior art, when accessing laser beams had the same wavelength, it was difficult to provide an interchangeability because the thickness of the light transmission layer differed greatly. However, as described above, when both BD content and HD DVD content are recorded into a single disc, either a BD apparatus or an HD DVD apparatus can play back the content, which provides a great benefit to the user.

<Basic Configuration of an Optical Disc of this Invention>

FIG. 9 shows the relationship between an optical disc (BD and DVD) 60 according to a first embodiment of the present invention and an optical head. The optical disc 60 is composed of a first signal substrate 61, a second signal substrate 71, and a first light transmission layer (cover layer) 66. In the optical disc 60, a first recording layer (corresponding to a BD layer) 62 made of a translucent film is formed closer to the incidence plane 65 of a laser beam in the first signal substrate 61 and a second recording layer (corresponding to a DVD layer) 72 made of a high reflection film is formed less close to the incidence plane in the second signal substrate 71. The first light transmission layer (cover layer) 66 is composed of a cover film 63 (of about 75 μm thick) and a first adhesive layer 64. The first light transmission layer 66 is formed to a thickness of 100±2 μm to prevent the occurrence of a spherical aberration of the objective lens 58. Since it is difficult to produce the first light transmission layer 66 with this accuracy, an error in the DC thickness is absorbed by the spherical aberration compensating lens 59. In an ordinary normal single layer disc, the DVD layer serving as the second recording layer is formed so as to be 600±30 μm from the incidence plane 65 (with jitter being 8% or less). If jitter can be decreased to 7% or less as in a dual layer disc, the DVD layer can be extended to 550 to 640 μm. In a recent dual layer DVD disc, progress in manufacturing techniques enables jitter to be reduced to 7% or less in the range of 550 to 640 μm.

If the center value of the thickness of the second adhesive layer is 25 μm, molding is done with the center value of the thickness of the first signal substrate 61 being 475 μm, which enables the distance of the second recording layer (DVD layer) 72 to be 600 μm after the cover layer 66 is bonded to the first signal substrate. Actually, the molding accuracy of the first signal substrate 61 (including the stamper accuracy), an error in the thickness of the first adhesive layer, an error in the thickness of the second adhesive layer, and the like are added. However, it is not so difficult to form the second recording layer within an accuracy of ±30 μm.

For example, if the thickness of the cover film 63 is 75±1 μm and about an error in the manufacture of HD DVD discs is taken into account, the thickness of the first adhesive layer 64 is 25±5 μm, the thickness of the first signal substrate 61 is 475±10 μm, and the thickness of the second adhesive layer 73 is 25±5 μm. As a result, the distance from the incidence plane 65 to the second recording layer 72, that is, the thickness of the light transmission layer 75 to the second recording layer 72, is 600±21 μm, leaving a margin for an error of ±30 μm. This margin can be given to the molding accuracy of the first signal substrate 61 or the adhesive thickness accuracy of the second adhesive layer 73. If the thickness of the light transmission layer 75 is extended to 550 to 640 μm, a margin can be increased that much.

The birefringence viewed from the second recording layer 72 is the sum of that of the first light transmission layer 66 and that of the second light transmission layer 74. The birefringence of the cover layer of the BD disc is determined to be 30 nm in a double path. When a cover film is used, the birefringence is estimated to be about 20 nm. On the other hand, since the birefringence of HD DVD is 60 nm in a double path, the birefringence of the light transmission layer 57 of the second recording layer is 80 nm or less in the worst double path.

The second recording layer (DVD layer) 72 is read with the red laser beam 17 and the first recording layer (BD layer) 62 is read with the blue-violet laser beam 37.

<Reflectivity and Others>

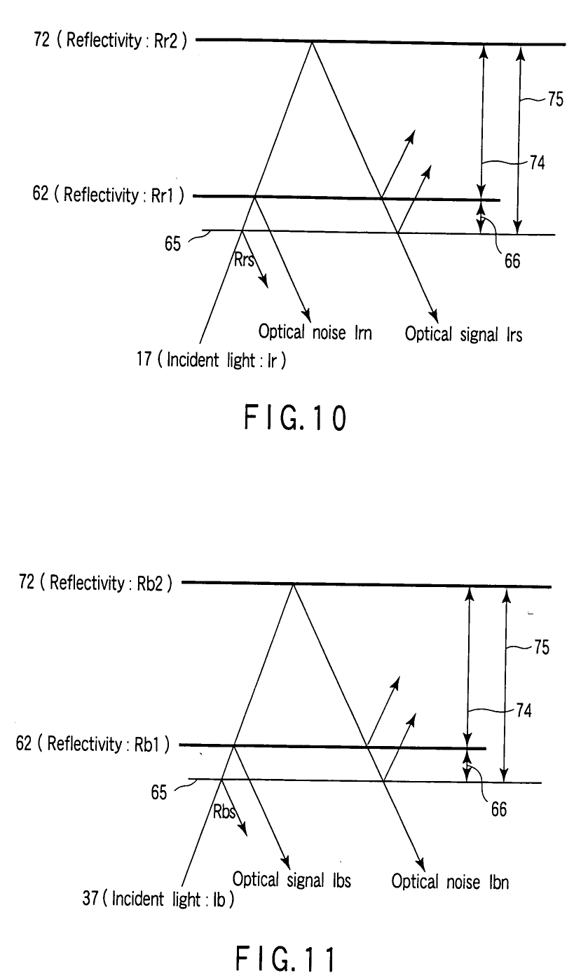

FIG. 10 shows a state where an optical disc 60 of the first embodiment is played back with a red laser beam. For the optical disc 60 to be recognized as a single-sided single layer DVD disc with one of the conventional DVD apparatuses commercially available in large quantities, the optical signal from the DVD layer 72 has to be 45% or more of the incident light with respect to the red laser beam 17 as shown in FIG. 10. If the blue-violet laser beam 37 is irradiated onto the same optical disc, the optical signal from the BD layer 62 must be such that focus servo and tracking servo are applied the signal can be reproduced as shown in FIG. 11.

The reflectivity of BD-ROM with respect to blue-violet laser light is determined as follows:

Single-sided single layer disc 35% to 70% (including birefringence)

Single-sided dual layer disc 12% to 28% (including birefringence)

Therefore, it is desirable that the reflectivity of the BD layer should be 12% or more. Since BD-ROM has not been produced on a commercial basis, even if the reflectivity is low, the apparatus can deal with the disc. For example, even if an HD DVD-rewritable disc has a reflectivity of 4% to 8%, the apparatus can deal with this disc.

In the case of a single-sided dual layer DVD disc shown in FIG. 3, since the reproducing light is the red laser beam 17, Au or Si is generally used as a translucent film in the first recording layer 24. In the second recording layer 27 of a high reflection film, low-cost Al alloy is used.

In the case of HD DVD shown in FIG. 6, however, use of Au or Si makes it difficult to form a translucent film in a suitable range for the blue-violet laser beam. Therefore, the translucent first recording layer (L0 layer) 44 may be made of Ag alloy and the high-reflection second recording layer (L1 layer) 47 may be made of Ag alloy or Al alloy.

Hereinafter, consideration will be given to a case where the first recording layer (BD layer) (translucent) 62 of the optical disc 60 is made of Ag alloy and the second recording layer (DVD layer) (high reflectivity) 72 is made of Ag alloy.

In FIG. 10, the reflectivity (Rrs) at the incidence plane, which is determined by the refractive index of the cover layer 66 with respect to the red laser beam 17, is about 4.8% (without antireflection). In the light transmission layer 75 with respect to the DVD layer 72, since the birefringence is 80 nm in a double path, a decrease in the amplitude due to the birefringence is 14.2% maximum.

The reflectivity Rr2 of the DVD layer made of Ag alloy is about 92% with respect to the red laser beam. Therefore, the optical signal Irs from the DVD layer 72 is 0.952²×(transmittance of BD layer)²×0.92×0.858×100%. For this value to become 45% or more, the transmittance of the BD layer has to be 79.3% or more with respect to the red laser beam. At this time, the reflectivity of the BD layer with respect to the red laser beam is 16.8%. Since the distance between the BD layer 62 and the DVD layer 72 is large, optical noise Irn reflected from the DVD layer hardly enters the photodetector for the optical signal Irs. Therefore, the optical noise can be ignored.

Next, using FIG. 11, calculations will be done when the blue-violet laser beam 37 is caused to enter the disc under the conditions. The reflectivity (Rbs) at the incidence plane 65 with respect to the blue-violet laser beam 37 is about 5%. A decrease in the amplitude due to birefringence (20 nm) in the cover layer 66 is 2.4%. Therefore, the optical signal Ibs from the BD layer is 4.4% (=0.947²×0.05×0.976×100%). Although the reflected light is smaller than the surface reflected light, it is large enough to apply focus servo.

On the other hand, since optical noise Ibn from the DVD layer 72 when data is reproduced with the blue-violet laser beam decreases by about 38% with the transmittance of the BD layer 62 being about 90%, the reflectivity of the DVD layer being 71%, and the birefringence of the blue-violet laser beam being 80 nm, the optical noise is 38% (=0.947²×0.9×0.71×0.662×100%). This value is much larger than 4.4% of the optical signal Ibs. However, since the distance between the BD layer and the DVD layer is large, optical noise reflected from the DVD layer hardly enters the photodetector. Therefore, the optical noise can be ignored. To reduce the reflected light, Au which presents high reflection (83%) to the red laser beam and low reflection (30%) to the blue-violet laser beam should be used. However, use of Au for the DVD layer has a disadvantage in that, since the reflectivity of Au is lower than that of Ag, the transmittance of the BD layer has to be increased and consequently the optical signal Ibs from the BD layer decreases.

The above calculations have been done on the assumption that the birefringence is the worst. Since the actual birefringence is much smaller, the reflectivity takes a much larger value.

<Flag Information>

Next, a set of flags in the optical disc 60 of the present invention will be explained. The DVD layer 72 has to be treated as an ordinary single-sided single layer DVD disc. ID of Data frame and BP2 in Physical format information in the Control data zone are set as a single-sided single layer disc. In addition, although the BD layer 62 has the same reflectivity as that of the dual layer disc, its flag is set as a single-sided single layer disc.

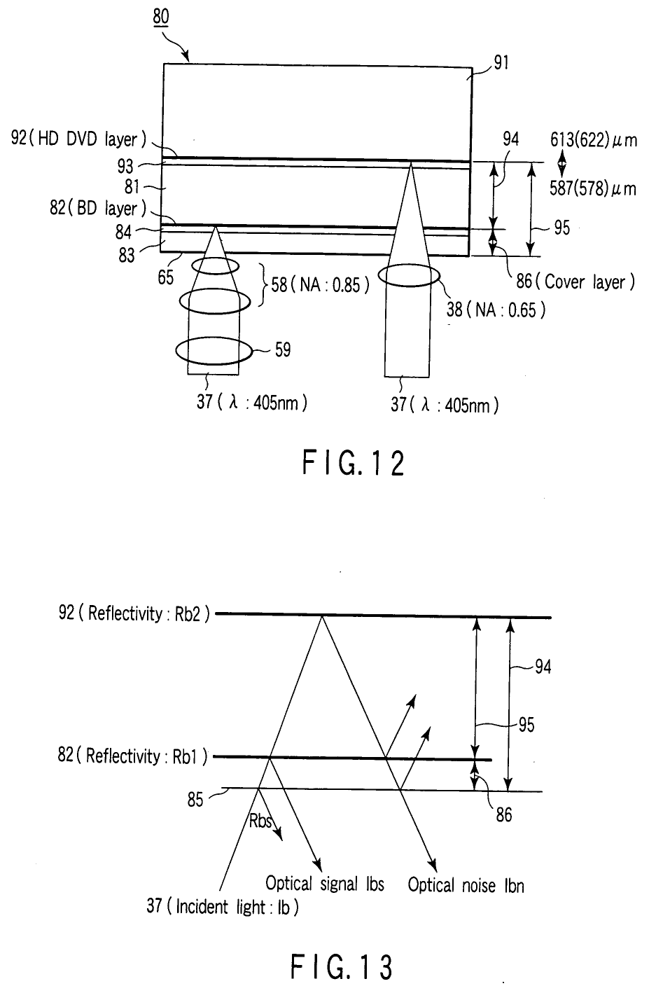

Hereinafter, the relationship between an optical disc (BD and HD DVD) 80 according to a second embodiment of the present invention and an optical head will be explained using FIG. 12. The optical disc 80 is composed of a first signal substrate 81, a second signal substrate 91, and a first light transmission layer (cover layer) 86. In the optical disc 80, a first recording layer (corresponding to a BD layer) 82 made of a translucent film is formed closer to the incidence plane 85 of a laser beam in the first signal substrate 81 and a second recording layer (corresponding to an HD DVD layer) 92 made of a high reflection film is formed less close to the incidence plane in the second signal substrate 91. The first light transmission layer (cover layer) 86 is composed of a cover film 83 (of about 75 μm thick) and a first adhesive layer 84. The first light transmission layer 86 is formed to a thickness of 100±2 μm to prevent the occurrence of a spherical aberration of the objective lens 58. Since it is difficult to produce the first light transmission layer 86 with this accuracy, an error in the DC thickness is absorbed by the spherical aberration compensating lens 59. The HD DVD layer serving as the second recording layer 92 is formed so as to be 600×22 μm from the incidence plane 85.

If the center value of the thickness of the second adhesive layer 93 is 25 μm, molding is done with the center value of the thickness of the first signal substrate 81 being 475 μm, which enables the distance of the second recording layer (HD DVD layer) 92 to be 600 μm after the cover layer 86 is bonde to the first signal substrate. Actually, the molding accuracy of the first signal substrate 81 (including the stamper accuracy), an error in the thickness of the first adhesive layer 84, an error in the thickness of the second adhesive layer 93, and the like are added. However, it is possible to form the second recording layer within an accuracy of ±22 μm.

For example, if the thickness of the cover film 83 is 75±1 μm and about an error in the manufacture of HD DVD discs is taken into account, the thickness of the first adhesive layer 84 is 25×5 μm, the thickness of the first signal substrate 81 is 475±10 μm, and the thickness of the second adhesive layer 93 is 25±5 μm. As a result, the distance from the incidence plane 85 to the second recording layer 92, that is, the thickness of the light transmission layer 95 to the second recording layer 92, is 600±21 μm, which enables the thickness of the light transmission layer to fall in the specific range of ±22 μm.

The birefringence viewed from the second recording layer 92 is the sum of that of the first light transmission layer 86 and that of the second light transmission layer 94. As in the first embodiment, the birefringence is 80 nm or less in a double path.

In the second embodiment, both the first recording layer (BD layer) and the second recording layer (HD DVD layer) 92 are read with the blue-violet laser beam 37.

<Reflectivity and Others>

FIG. 13 shows a case where the optical disc 80 of the second embodiment is played back with the blue-violet laser beam 37, particularly a case where the BD layer 82 is accessed with the blue-violet laser beam 37 and a case where the HD DVD layer 92 is accessed with the blue-violet laser beam 37.

The reflectivity of BD-ROM with respect to blue-violet laser light is determined as described above:

Single-sided single layer disc 35% to 70% (including birefringence)

Single-sided dual layer disc 12% to 28% (including birefringence)

In HD DVD

Single-sided single layer disc 40% to 70% (including birefringence)

Single-sided dual layer disc 18% to 32% (including birefringence)

Specifically, the optical signal from the BD layer has to be 12% or more of the incident light, whereas the optical signal from the HD DVD layer has to be 18% or more of the incident light.

Hereinafter, as in the first embodiment, consideration will be given to a case where the first recording layer (BD layer) (translucent) 82 of the optical disc 80 is made of Ag alloy and the second recording layer (HD DVD layer) (high reflectivity) 92 is made of Ag alloy.

In FIG. 13, since the reflectivity (Rrs) at the incidence plane 85 is about 5.3% (without antireflection) and the birefringence at the cover layer 86 is 30 nm (the specified value in BD), a decrease in the amplitude is 5.3% maximum. For the optical signal Ibs from the BD layer 82 to be 12% or more of the incident light Ib, the reflectivity Rb1 of the BD layer with respect to the blue-violet layer beam 37 has to be 14.1% or more (=0.12×100%/(0.947²×0.947)). As in the first embodiment, optical noise Ibn can be ignored.

Next, a case where the HD DVD layer 92 is accessed with the blue-violet layer beam 37 will be explained. If the reflectivity of the BD layer 82 is set a little high, or 16%, the transmittance is 76%. If the birefringence of the light transmission layer 95 with respect to the HD DVD layer 92 is 80 nm, a decrease in the amplitude due to the birefringence is 38% maximum. The reflectivity Rb2 of the HD DVD layer 92 made of Al alloy is 71%. Therefore, the optical signal Ibs from the HD DVD layer 92 is 19.5% (=0.947²×0.662×0.71×0.762×100%). This disc satisfies the requirements of the HD DVD dual layer disc.

As described above, when the BD layer and the HD DVD layer are provided in a single disc, the reflectivity of the BD layer and that of the HD DVD layer can meet the requirements of the reflectivity of the dual layer disc.

<Flag Information>

Next, a set of flags in the optical disc of the present invention will be explained. Both the BD layer and the HD DVD layer have to be treated as an ordinary single-sided single layer DVD disc. The flags are set as a single-sided single layer disc.

<Reproduction by an Optical Disc Apparatus Complying with the DVD Standard>

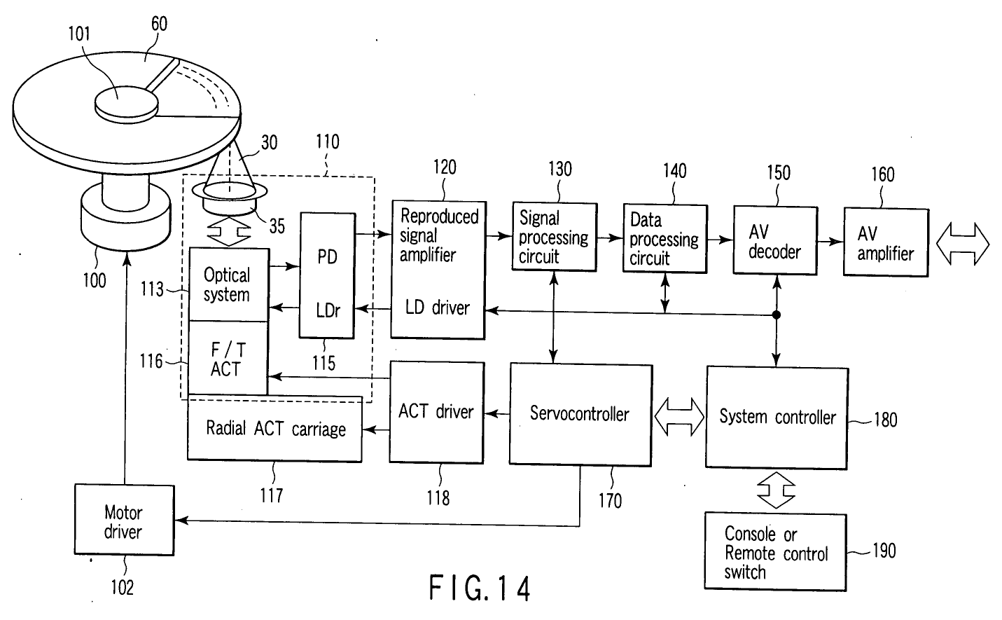

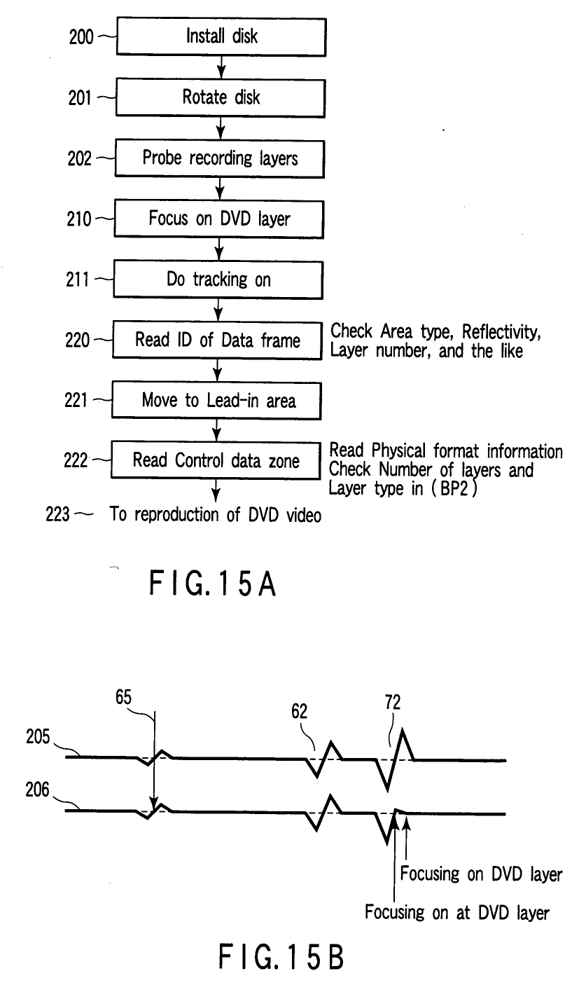

Next, a case where the optical disc 60 of the first embodiment is played back on a conventional DVD apparatus will be explained using FIGS. 14, 15A, and 15B. FIG. 14 shows the main configuration of a well-known DVD apparatus. FIG. 15A is a flowchart to help explain the operation of the DVD apparatus. FIG. 15B shows its focus servo.

The main configuration of the DVD apparatus will be explained briefly. A spindle motor 100 rotates a turntable. A clamper 101 holds the optical disc 60 in place on the turntable. The spindle motor 100 is controlled by a motor driver 102. An optical head 110 includes an objective lens 35 and an optical system 113. The optical system 113 is driven by a focus and tracking actuator (F/T ACT) 116. When the focus and tracking actuator 116 is controlled by an actuator driver (ACT driver) 118, the laser beam is focused on a track on the optical disc and follows the track. A radial actuator carriage (Radial ACT carriage) 117 is used to move the optical head 110 in the direction of radius of the disc and is controlled by the actuator

The reflected light from the disc is taken out of the optical system 113 and is converted into an electric signal at a photodetector (PD) in a conversion unit 115. The electric signal is gain-adjusted at a reproduced signal amplifier in a gain adjusting unit 120 and the resulting signal is input to a signal processing circuit 130. The signal processing circuit 130 performs a demodulating process, buffering, error correction, and others and inputs the resulting signal to a data processing circuit 140. The data processing circuit 140 performs packet separation, control signal separation, and the like and inputs video and audio information to an AV decoder 150. The video signal, audio signal, sub-video signal, and the like demodulated at the AV decoder 150 are output as a baseband signal via an AV amplifier 160.

Using a focus error signal and tracking error signal obtained by, for example, processing numerically the reproduced signal from a 4-quadrant photodiode, a servo controller 170 supplies a control signal to the actuator driver 118. In response to a signal from a console (e.g., a remote controller or an operation key input section) 190, a system controller 180 controls the playback, stop, and temporary stop of the apparatus, and the like. In addition, the system controller 180 controls the laser diode driver in the gain adjusting unit 120. The laser diode driver drives the laser diode installed in the optical head 110, thereby outputting a red laser beam 30.

When the optical disc 60 of the present invention is installed in the DVD apparatus, the spindle motor 100 is rotated until a specific number of revolutions has been reached. Next, a periodic driving current is caused to flow through the focus actuator 116, thereby moving the optical head up and down in the direction of axis (in step 200 to step 202 in FIG. 15A). A focus signal 205 produced from the reproduced signal appears periodically (see FIG. 15B). Since the level of the focus signal from the DVD layer is several times as large as the level of the signal from the BD layer, most of the DVD apparatuses recognize the disc as a single-sided single layer DVD disc and apply focus servo to the DVD layer (step 210) as shown by numeral 206 in FIG. 15B.

Then, after a short stabilization time elapses, the DVD layer is focused on. Then, the tracking servo is turned on, thereby tracking on a suitable position of the disc (step 211). In this state, ID of Data frame is read (step 220) and Area type, Reflectivity, Layer number, and others of the disc are checked. Then, the radial actuator 117 is driven, moving the optical head 110 to the lead-in area (step 221). Next, the optical head is moved to the Control data zone (step 222) and reads Number of layers and Layer type from (BP2) in Physical formation information, thereby verifying that the disc is a single-sided single layer DVD disc, which is followed by the reproduction of DVD video (step 223).

Depending on the apparatus, the disc might be determined to be a single-sided dual layer DVD disc, although the level of the signal from the BD layer is small. However, since a specific signal cannot be obtained from the BD layer, the DVD layer is focused on again and then read.

### Other Embodiments

In the above embodiments, the translucent film of the first recording layer has been made of Ag alloy. If reflectivity and transmittance can be selectively set for each of the two laser beams differing in wavelength, the apparatus can be operated more efficiently.

Although in FIGS. 14, 15A, and 15B, the flow of the operation when the optical disc (BD and DVD) 60 has been installed in the DVD apparatus has been explained, the present invention is not limited to this. For instance, the invention may be applied to a case where the optical disc (BD and HD DVD) 80 has been installed in the HD DVD apparatus.

According to the present invention, it is possible to provide an optical disc which enables a first recording layer (corresponding to a BD layer) and a second recording layer (corresponding to a DVD layer) to be accessed from one side with a first laser beam (blue-violet laser light) and a second laser beam (red laser light), respectively. Therefore, BD content and DVD content can be recorded into a single disc, which enables the user to enjoy the DVD content even with a conventional apparatus without a BD reproducing function. Moreover, use of an apparatus with a BD reproducing function enables the user to enjoy BD content (e.g., HD content).

In another example, it is possible to provide an optical disc which enables a first recording layer (corresponding to a BD layer) and a second recording layer (corresponding to an HD DVD layer) to be accessed from one side with a first laser beam (blue-violet laser light) and a second laser beam (blue-violet laser light), respectively. In the prior art, when accessing laser beams had the same wavelength, it was difficult to provide an interchangeability because the thickness of the light transmission differed greatly. However, as described above, when both BD content and HD DVD content are recorded onto a single disc, both a BD apparatus and an HD DVD apparatus can play back the content, which provides a great benefit to the user.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical disc of a single-sided dual layer comprising:
a first light transmission layer;
a first recording layer which is accessed with a first laser beam;
a second light transmission layer; and
a second recording layer which is accessed with a second laser beam, these layers being arranged in that order from an incidence plane in the direction of incidence,
the distance from the incidence plane to the second recording layer being 570 μm to 630 μm, and
the areal recording density of the first recording layer being five times or more as high as that of the second recording layer.

2. The optical disc according to claim 1, wherein the distance from the incidence plane to the first recording layer is about 100 μm,
the reflectivity of the first recording layer with respect to the first laser beam is 4% or more, and
the reflectivity of the second recording layer with respect to the second laser beam is 45% or more.

3. An optical disc of a single-sided dual layer comprising:
a first light transmission layer;
a first recording layer which is accessed with a first laser beam;
a second light transmission layer; and
a second recording layer which is accessed with a second laser beam, these layers being arranged in that order from-an incidence plane in the direction of incidence,
the distance from the incidence plane to the second recording layer being 578 to 622 μm, and
the areal recording density of the first recording layer being 1.5 times or more as high as that of the second recording layer.

4. The optical disc according to claim 3, wherein the distance from the incidence plane to the first recording layer is about 100 μm,
the reflectivity of the first recording layer with respect to the first laser beam is 12% or more, and
the reflectivity of the second recording layer with respect to the second laser beam is 18% or more.

5. An optical disc apparatus which reads information recorded on an optical disc which includes a first light transmission layer, a first recording layer accessed with a first laser beam, a second light transmission layer, and a second recording layer accessed with a second laser beam, these layers being arranged in that order from an incidence plane in the direction of incidence, the distance from the incidence plane to the second recording layer being 570 to 630 μm, and the areal recording density of the first recording layer being five times or more as high as that of the second recording layer, the optical disc apparatus comprising:
an optical head capable of generating the second laser beam; and
reproducing means for reading the information on the basis of the second laser beam generated by the optical head.

6. An optical disc reproducing method of reading information recorded on an optical disc which includes a first light transmission layer, a first recording layer accessed with a first laser beam, a second light transmission layer, and a second recording layer accessed with a second laser beam, these layers being arranged in that order from an incidence plane in the direction of incidence, the distance from the incidence plane to the second recording layer being 570 to 630 μm, and the areal recording density of the first recording layer being five times or more as high as that of the second recording layer, the optical disc reproducing method comprising:
generating the second laser beam; and
reading the information on the basis of the second laser beam.
